(19) United States
(12) Patent Application Publication
(10) Pub. No.: US 2005/0259375 A1
(43) Pub. Date: Nov. 24, 2005

(54) Overcurrent protection circuit

(75) Inventors: Hideharu Akimura, Miyagi (JP); Shigeru Kataoka, Kanagawa (JP); Tougo Nakatani, Osaka (JP)

Correspondence Address: MCDERMOTT WILL & EMERY LLP, 600 13TH STREET, N.W., WASHINGTON, DC, 20005-3096, US

(73) Assignee: MATSUSHITA ELECTRIC INDUSTRIAL CO., LTD.

(21) Appl. No.: 11/121,137

(22) Filed: May 4, 2005

(30) Foreign Application Priority Data
May 20, 2004 (JP) 2004-150166

(51) Int. Cl. H02H 3/08

(52) U.S. Cl. 361/93.1

(57) ABSTRACT

An overcurrent protection circuit according to the present invention includes: overcurrent detecting means for detecting a flow of an overcurrent in a load circuit; and voltage controlling means for changing a power supply voltage and supplying the resultant power supply voltage to the load circuit. The overcurrent detecting means detects a voltage decrease occurring when an overcurrent is generated, with respect to a voltage supplied to the load circuit during normal operation. The voltage controlling means suppresses an overcurrent flowing in the load circuit based on the voltage decrease.

### CROSS-REFERENCE TO RELATED APPLICATION

The disclosure of Japanese Patent Application No. 2004-150166 filed on May 20, 2004 including specification, drawings and claims is incorporated herein by reference in its entirety.

### BACKGROUND OF THE INVENTION

The present invention relates to overcurrent protection circuits.

An example of a conventional overcurrent protection circuit for detecting an overcurrent in a load is a circuit disclosed in Japanese Unexamined Patent Publication (Kokai) No. 8-331758. This circuit is shown in FIG. 8 and overviews of configuration and operation thereof will be hereinafter described.

In FIG. 8, a power metal oxide semiconductor field effect transistor (MOSFET) 10 has a multi-source configuration, more specifically has a first source 10a and a second source 10b.

The drain of the power MOSFET 10 is connected to a power supply terminal 20 and the first source 10a serving as a current output terminal is connected to a current output terminal 11 of an integrated circuit (IC) serving as an external load connection terminal. The current output terminal 11 is also connected to a load circuit 12. The second source 10b serves as a current detection terminal and is connected to a resistor 21. The resistor 21 has a function of converting a current flowing in the second source 10b into a voltage signal and outputting the voltage signal.

The voltage signal output from the resistor 21 is input to a linear voltage comparator 22 as an input voltage Vᵢₙ. The voltage comparator 22 includes a differential pair composed of a first PNP transistor Q1 and a second PNP transistor Q2. The first PNP transistor Q1 receives the input voltage Vᵢₙ and the second PNP transistor Q2 receives a given reference voltage V_{ref}. When the input voltage Vᵢₙ exceeds the reference voltage V_{ref}, i.e., a detection current flowing in the current detection terminal 10b becomes an overcurrent, the voltage comparator 22 outputs a current according to the overcurrent.

In this manner, the output current from the voltage comparator 22 according to the overcurrent is input to the base of an output transistor 23, which is an NPN transistor.

The collector and emitter of the output transistor 23 are connected between an output node of a power FET driver 13 and a ground node. The power FET driver 13 controls the amount of supply of a charging current from a current source incorporated therein, thereby controlling the gate potential of the power MOSFET 10.

The voltage comparator 22 and the output transistor 23 constitute a voltage comparison power controlling circuit 24. The voltage comparison power controlling circuit 24 detects an overcurrent in the power MOSFET 10 and draws an output current from the power FET driver 13 according to the overcurrent into the ground potential, thereby controlling the gate potential of the power MOSFET 10. This stops the flow of an overcurrent to the load circuit 12, so that breakdown of the load circuit 12 caused by the overcurrent is prevented.

In summary, the second source 10b of the power MOSFET 10 having the multi-source configuration is used as a current detection terminal and a current smaller than a current output to the first source 10a is output from the second source 10b. The current output from the second source 10b is converted into a voltage signal by the fixed resistor 21. The voltage signal is used as an input voltage Vᵢₙ and is compared with a given reference voltage V_{ref} by the voltage comparator 22. The output transistor 23 is controlled based on the potential difference between the input voltage Vᵢₙ and the reference voltage V_{ref}. The output transistor 23 adjusts the ground potential of the power FET driver 13, thereby controlling the gate potential of the power MOSFET 10. In this manner, the flow of an overcurrent to the load circuit 12 is stopped.

### SUMMARY OF THE INVENTION

However, the conventional voltage comparison overcurrent protection circuit described above has a drawback in which the amount of current flowing in the load circuit 12 is adjusted only based on a given voltage. This is because a current signal output from the second source 10b is converted into a voltage signal by the fixed resistor 21 and is compared, as an input voltage Vᵢₙ, with a reference voltage V_{ref}.

In addition, as another drawback of the conventional circuit, the conversion of a current into a voltage signal for the potential-difference comparison with the reference voltage as described above needs the resistor 21 exclusively used for voltage conversion and requiring high accuracy.

Further, the set value of the reference voltage V_{ref} needs to be adjusted (set) for each overcurrent protection circuit in accordance with variation of the resistance value of the resistor 21.

Moreover, the value of a current flowing at the output needs to be predicted beforehand so that the reference voltage V_{ref} is adjusted based on the prediction.

Furthermore, in a case where the value of a voltage input to the circuit is changeable, e.g., in the case of a system or the like that is used in, for example, a cellular phone and controls the power of a power amplifier by changing the voltage, the reference voltage V_{ref} cannot follow the input voltage, so that an overcurrent is not detected appropriately.

It is therefore an object of the present invention to provide a current protection circuit capable of preventing an overcurrent based on a relative potential difference according to an output voltage level without the need for a resistor with high accuracy exclusively used for current detection and the necessity of setting a reference voltage according to a current value of an output.

In order to achieve this object, an overcurrent protection circuit according to the present invention includes: overcurrent detecting means for detecting a flow of an overcurrent in a load circuit; and voltage controlling means for changing the level of a power supply voltage and supplying the resultant power supply voltage to the load circuit as a constant output voltage. The overcurrent detecting means detects a voltage decrease of the output voltage occurring during generation of an overcurrent. The voltage controlling means suppresses a current supplied to the load circuit based on the voltage decrease.

In this circuit, an overcurrent flowing in the load circuit is detected by detecting a voltage decrease of an output voltage to be output to the load circuit. In addition, the overcurrent is suppressed by suppressing a current supplied to the load circuit based on the voltage decrease.

The voltage decrease is caused by an internal resistance of the circuit. Therefore, it is unnecessary to use a voltage conversion resistor with high accuracy for converting a current into a voltage signal. This also eliminates the need for adjustment of a reference voltage according to a variation in the voltage conversion resistor.

The voltage controlling means preferably includes: a voltage changer for changing the level of a received power supply voltage and for supplying the resultant power supply voltage to the load circuit as a constant output voltage; and a voltage comparator for supplying a reference voltage for use in comparison with the output voltage in the overcurrent detecting means.

Then, a constant output voltage is supplied to the load circuit. In addition, a reference voltage for detection of a voltage decrease occurring during generation of an overcurrent in the load circuit by the overcurrent detecting means is supplied, thus ensuring control of an overcurrent.

The voltage changer preferably includes: a first noninverting amplifier including a first feedback circuit; and a large-current driving circuit for suppressing a decrease of the power supply voltage caused by a supply of a current to the load circuit.

Then, the supply of a constant output voltage to the load circuit is ensured. In addition, the supply of a current necessary for the load circuit is also ensured.

The voltage comparator preferably includes a second noninverting amplifier including a second feedback circuit. The voltage comparator preferably changes the level of a received power supply voltage also input to the voltage changer and supplies the resultant power supply voltage to the overcurrent detecting means as a constant reference voltage.

Then, the supply of a reference voltage for detecting an overcurrent by comparison with an output voltage in the overcurrent detecting means is ensured.

The first feedback circuit in the voltage changer has a first feedback coefficient larger than a second feedback coefficient of the second feedback circuit in the voltage comparator.

Then, the output voltage and the reference voltage are compared with each other in the overcurrent detecting means, thus ensuring detection and control of an overcurrent based on a voltage decrease of the output voltage occurring during generation of an overcurrent in the load circuit. The output voltage is the product of an input voltage and the first feedback coefficient. The reference voltage is the product of the input voltage and the second feedback coefficient. The reference voltage is determined based on the input voltage in this manner, so that an overcurrent is detected in accordance with a change of the input voltage.

The overcurrent detecting means preferably includes: a first NPN transistor having a base to which the output voltage is supplied; a second NPN transistor having a base to which the reference voltage is supplied; a first PNP transistor for supplying a bias to the first NPN transistor; a second PNP transistor for supplying a bias to the second NPN transistor; a constant current source for driving the first PNP transistor and the second PNP transistor; and an output PNP transistor for controlling the large-current driving circuit. The first NPN transistor and the second NPN transistor preferably form a differential pair controlled based on a potential difference between the output voltage and the reference voltage. The output PNP transistor is preferably controlled by operation of the differential pair.

Then, the differential pair ensures comparison between the output voltage and the reference voltage and detection of a voltage decrease of the output voltage occurring due to generation of an overcurrent in the load circuit. In addition, the output PNP transistor is controlled based on the detected voltage decrease and a large-current driving circuit in the voltage changer is operated accordingly, thereby suppressing an overcurrent in the load circuit.

The overcurrent detecting means preferably includes a dual-gate PMOSFET instead of the output PNP transistor. The dual-gate PMOSFET preferably has a first gate connected to a collector of the second NPN transistor. The dual-gate PMOSFET preferably has a second gate controlled according to an external signal.

Then, the first gate provides the advantage of suppressing generation of an overcurrent in the load circuit. The second gate provides the advantage of enabling ON/OFF control of function of the overcurrent protection circuit according to an external signal and timing control thereof.

The second noninverting amplifier is preferably constituted by a third PNP transistor. The third PNP transistor preferably has a base connected to an input of the voltage changer. The third PNP transistor preferably has an emitter connected to the base of the second NPN transistor and to the constant current source.

Then, the configuration of the voltage comparator is simplified, thus enabling reduction of size and power consumption of a semiconductor device.

In the overcurrent protection circuit according to the present invention described above, an overcurrent generated in the load circuit is detected as a voltage decrease in the voltage changer for supplying an output voltage to the load circuit, and the overcurrent is suppressed based on this detection. Accordingly, it is possible to prevent breakdown of circuits such as the large-current driving circuit in the voltage changer and the load circuit from being caused by the overcurrent.

In addition, the detection of the voltage decrease for overcurrent detection is performed by comparing an output voltage from the voltage changer and an output voltage from the voltage comparator with each other with utilization of the differential pair. This eliminates the need for a voltage conversion resistor with high accuracy and the necessity of setting a reference voltage according to variation of the resistance value of the resistor. In addition, it is also possible to control an overcurrent even when an input voltage is changeable.

### BRIEF DESCRIPTION OF THE DRAWINGS

FIG. 1 is a block diagram illustrating an overcurrent protection circuit according to a first embodiment of the present invention.

FIG. 2 is a block diagram for explaining voltage control circuit according to the first embodiment.

FIG. 3 is a diagram illustrating an example of a voltage changer according to the first embodiment.

FIG. 4 is a diagram illustrating an example of a voltage comparator according to the first embodiment.

FIG. 5 is a diagram illustrating an example of an overcurrent protection circuit according to the first embodiment.

FIG. 6 is a diagram illustrating an example of an overcurrent protection circuit according to a modified example of the first embodiment.

FIG. 7 is a diagram illustrating an example of an overcurrent protection circuit according to a second embodiment of the present invention.

FIG. 8 is a diagram illustrating a conventional voltage comparison current controlling circuit and a conventional overcurrent limiting circuit.

### DESCRIPTION OF THE PREFERRED EMBODIMENTS

### Embodiment 1

Hereinafter, an overcurrent protection circuit according to a first embodiment of the present invention will be described with reference to drawings.

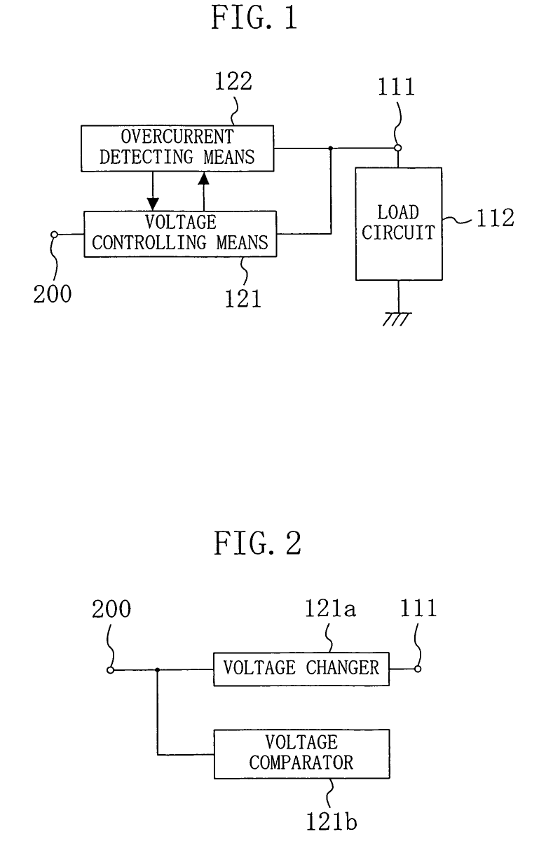

FIG. 1 is a block diagram illustrating an entire configuration of an overcurrent protection circuit according to this embodiment.

The overcurrent protection circuit of the first embodiment includes a voltage controlling means 121 and an overcurrent detecting means 122.

The voltage controlling means 121 changes a voltage input from a voltage input terminal 200 into a constant output voltage Vₒᵤₜ and supplies the output voltage Vₒᵤₜ and a constant current to a current output terminal 111. The current output terminal 111 is connected to a load circuit 112.

The overcurrent detecting means 122 detects a decrease of the output voltage Vₒᵤₜ in normal operation caused by generation of an overcurrent in the load circuit 112. The overcurrent detecting means 122 adjusts a current to be supplied to the current output terminal 111 by controlling the voltage controlling means 121 based on the voltage decrease, thereby suppressing the overcurrent in the load circuit 112.

FIG. 2 is a block diagram illustrating the voltage controlling means 121. The voltage controlling means 121 includes a voltage changer 121a and a voltage comparator 121b.

The voltage changer 121a includes a large-current driving circuit, changes the level of a voltage input from the voltage input terminal 200, and supplies the resultant voltage to the current output terminal 111 as a constant output voltage Vₒᵤₜ.

The voltage comparator 121b receives, from the voltage input terminal 200, an input voltage equal to that input to the voltage changer 121a, changes the level of the input voltage and supplies, to the overcurrent detecting means 122, a reference voltage V_{ref} for comparison with the output voltage Vₒᵤₜ from the voltage changer 121a.

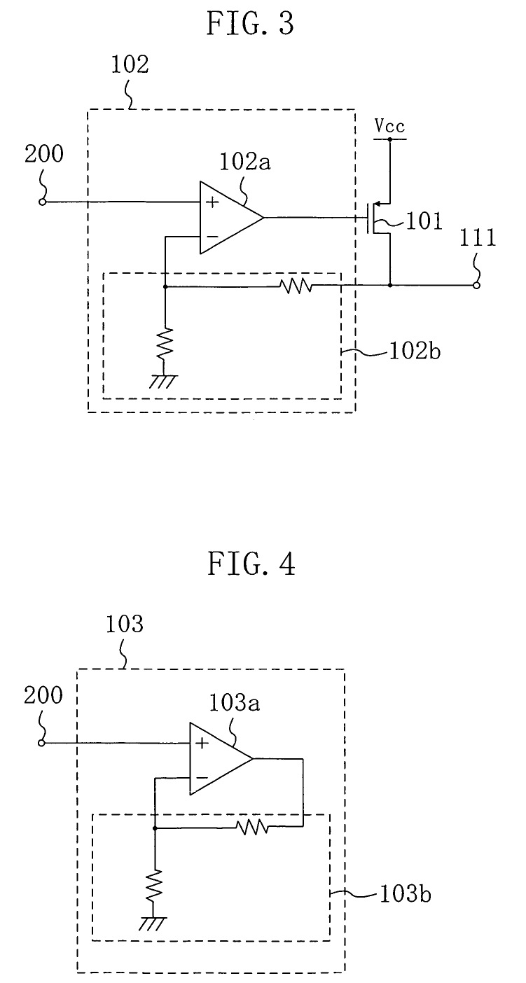

FIG. 3 illustrates a specific example of a circuit for implementing a function of the voltage changer 121a. In this embodiment, the voltage changer 121a includes: a first noninverting amplifier 102 provided with an amplifier 102a and a first feedback circuit 102b connected to a terminal of the amplifier 102a and having a constant gain; and a power p-channel MOSFET (PMOSFET) 101 capable of driving a large current with its gate connected to the output of the amplifier 102a. The first feedback circuit 102b has a first feedback coefficient (gain) and is connected to the drain of the power PMOSFET 101 and the current output terminal 111. A voltage is input to a + (positive) terminal of the amplifier 102a from the voltage input terminal 200.

With this configuration, the level of the voltage input from the voltage input terminal 200 is changed in the first feedback circuit 102b and is supplied to the drain of the power PMOSFET 101 and the current output terminal 111 as a constant output voltage Vₒᵤₜ. The output voltage Vₒᵤₜ is also supplied to the overcurrent detecting means 122. The Vₒᵤₜ is herein the product of the input voltage and the first feedback coefficient.

Since the gate of the power PMOSFET 101 is connected to the first amplifier 102a, the gate voltage V_{gs} (voltage difference between gate and source) of the power PMOSFET 101 is controlled in accordance with the output voltage Vₒᵤₜ. Accordingly, a source/drain current I_{ds} flows in the power PMOSFET 101, so that a current necessary for the current output terminal 111 is supplied.

FIG. 4 illustrates a specific example of a circuit for implementing a function of the voltage comparator 121b. In this embodiment, the voltage comparator 121b includes a second noninverting amplifier 103 provided with an amplifier 103a and a second feedback circuit 103b connected to a terminal of the amplifier 103a. The voltage comparator 121b has a constant gain. The second feedback circuit 103b has a second feedback coefficient. A voltage equal to the input to the voltage changer 121a is input to a + (positive) terminal of the amplifier 103a from the voltage input terminal 200.

With this configuration, the level of the voltage input from the voltage input terminal 200 is changed in the second feedback circuit 103b and is supplied to the overcurrent detecting means 122 as a reference voltage V_{ref}. The reference voltage V_{ref} is herein the product of the input voltage and the second feedback coefficient.

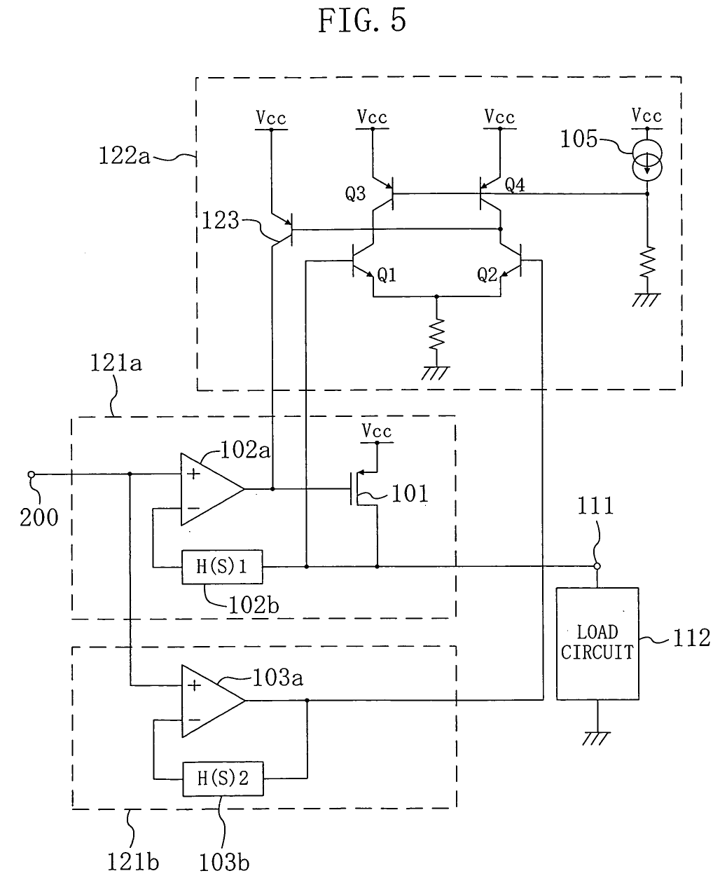

FIG. 5 illustrates a specific example of an overcurrent detector 122a for implementing a function of the overcurrent detecting means 122 and also shows a relationship among the overcurrent detector 122a, the voltage changer 121a and the voltage comparator 121b in detail.

The overcurrent detector 122a in this embodiment includes a first NPN transistor Q1 and a second NPN transistor Q2. The first and second NPN transistors Q1 and Q2 have their emitters connected to each other and form a differential pair.

The collector of the first NPN transistor Q1 is connected to the collector of a first PNP transistor Q3 for applying a bias to the first NPN transistor Q1. The collector of the second NPN transistor Q2 is connected to the collector of a second PNP transistor Q4 for applying a bias to the second NPN transistor Q2. The bases of the first PNP transistor Q3 and the second PNP transistor Q4 are connected to a constant current source 105. The constant current source 105 applies a bias to the first PNP transistor Q3 and the second PNP transistor Q4.

The collector of the second NPN transistor Q2 constituting the differential pair is connected to the base of an output PNP transistor 123. The emitter of the output PNP transistor 123 is connected to a power supply. The collector of the output PNP transistor 123 is connected to the gate of the power PMOSFET 101. This configuration enables the output PNP transistor 123 to control the gate voltage V_{gs} of the power PMOSFET 101.

The first amplifier 102a, the first feedback circuit 102b and the power PMOSFET 101 constitute the voltage changer 121a shown in FIG. 3. As described above, in the voltage changer 121a, the input voltage from the voltage input terminal 200 is changed into a constant output voltage Vₒᵤₜ and is supplied to the current output terminal 111 and the base of the first NPN transistor Q1 in the overcurrent detecting means 122. The output voltage Vₒᵤₜ is herein the product of the input voltage and the first feedback coefficient. The current output terminal 111 is connected to the load circuit 112.

The second amplifier 103a and the second feedback circuit 103b constitute the voltage comparator 121b shown in FIG. 4. As described above, in the voltage comparator 121b, the input voltage from the voltage input terminal 200 is changed into a reference voltage V_{ref} and is supplied to the base of the second NPN transistor Q2 in the overcurrent detecting means 122. The reference voltage V_{ref} is herein the product of the power supply voltage and the second feedback coefficient.

The first feedback coefficient of the first feedback circuit 102b is set at a value larger than the second feedback coefficient of the second feedback circuit 103b, so that the base potential of the first NPN transistor Q1 is higher than that of the second NPN transistor Q2.

With the foregoing configuration, during normal operation with no overcurrent flowing in the load circuit 112, all the current in the differential pair flows in the first NPN transistor Q1. Since the first NPN transistor Q1 is ON, a constant current flows in the first PNP transistor Q3. On the other hand, since no current flows in the second NPN transistor Q2, i.e., the second NPN transistor Q2 is OFF, no current flows in the second PNP transistor Q4 and the second PNP transistor Q4 is OFF. Accordingly, no bias is applied to the base of the output PNP transistor 123, so that the output PNP transistor 123 is OFF. The gate voltage V_{gs} of the power PMOSFET 101 causes a source/drain current I_{ds} to flow, and a constant voltage and a constant current are supplied to the load circuit 112.

Now, a case where a current flowing in the load circuit 112 increases for some reason will be described.

In such a case, the source/drain current I_{ds} increases so as to supply a current to the load circuit 112, so that the ON resistance of the power PMOSFET 101 reduces the output voltage Vₒᵤₛ. This causes the output voltage Vₒᵤₜ supplied to the base of the first NPN transistor Q1, which is one of the two transistors forming the differential pair for detecting a potential difference, to decrease, while causing the reference voltage V_{ref} supplied to the base of the second NPN transistor Q2, which is the other one of the two transistors, to exceed the output voltage Vₒᵤₜ. Accordingly, the second NPN transistor Q2 operates and a bias is applied to the base of the output PNP transistor 123, so that the output PNP transistor 123 operates.

When the output PNP transistor 123 operates in the manner described above, the gate voltage V_{gs} of the power PMOSFET 101 increases and the source/drain current I_{ds} decreases. In this manner, a current flowing in the load circuit 112 is limited and an overcurrent is suppressed.

As described above, in the overcurrent protection circuit of the first embodiment, the output voltage Vₒᵤₜ supplied from the voltage changer 121a and the reference voltage V_{ref} supplied from the voltage comparator 121b are compared with each other in the overcurrent detector 122a including the differential pair. When a current flowing in the load circuit 112 increases, the output voltage Vₒᵤₜ decreases because of the ON resistance of the power PMOSFET 101 in the voltage changer 121a. This voltage decrease is detected by the overcurrent detector 122a. Specifically, out of the two transistors forming the differential pair, the potential at the base of the second NPN transistor Q2 to which the reference voltage V_{ref} is supplied is higher than that at the base of the first NPN transistor Q1 to which output voltage Vₒᵤₜ is supplied. Accordingly, the second NPN transistor Q2, which is OFF during normal operation, turns ON, so that a bias is applied to the base of the output PNP transistor 123 and the output PNP transistor 123 is caused to operate. The operating output PNP transistor 123 raises the gate voltage V_{gs} of the power PMOSFET 101 in the voltage changer 121a and reduces the source/drain current I_{ds}. As a result, the current flowing in the load circuit 112 is limited, and an overcurrent is prevented. In this manner, it is possible to prevent breakdown of the load circuit 112 and the power PMOSFET 101 caused by the overcurrent.

In this embodiment, the voltage comparator 121b is configured as a noninverting amplifier including the second amplifier 103a and the second feedback circuit 103b. Alternatively, instead of this configuration, a third PNP transistor Q5 may be used. In such a case, the third PNP transistor Q5 has its base connected to the voltage input terminal 200, its collector grounded to a GND and its emitter connected to the constant current source 105 and to the base of the second NPN transistor Q2.

With this configuration, the level of the input voltage is changed by a degree corresponding to the voltage V_{be} (voltage between base and emitter) of the third PNP transistor Q5 and is supplied to the base of the second NPN transistor Q2 as a reference voltage V_{ref}. The reference voltage V_{ref} is set at a level lower than that of the output voltage Vₒᵤₜ.

In this manner, the function of the voltage comparator 121b is implemented by using the transistor, and the circuit is simplified. As a result, power consumption is reduced and the semiconductor device is downsized.

### Modified Example of Embodiment 1

Hereinafter, an overcurrent protection circuit according to a modified example of the first embodiment will be described with reference to drawings.

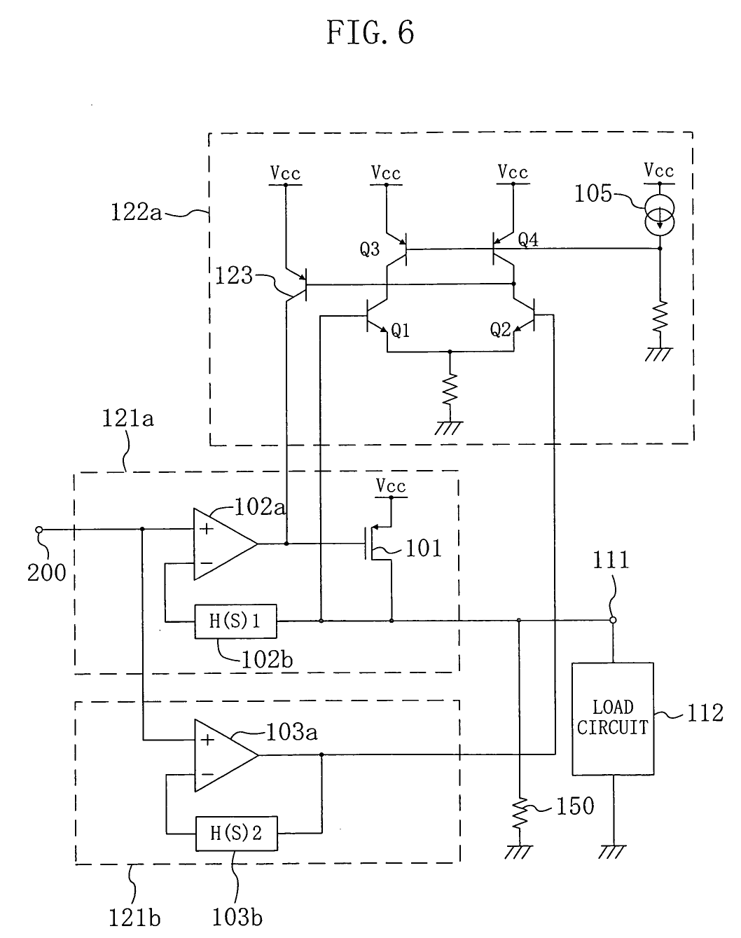

FIG. 6 is a diagram illustrating a specific example of a circuit for implementing a function of the overcurrent protection circuit of this modified example. In FIG. 6, the same components as those of the overcurrent protection circuit of the first embodiment shown in FIG. 5 are denoted by the same reference numerals, and the description thereof will be omitted.

The modified example of the first embodiment is different from the first embodiment in that an impedance fixing resistor 150 is inserted between the current output terminal 111 and the GND and, thereby, the impedance upon no application of a load is reduced.

In the overcurrent protection circuit of this modified example, the following advantages are obtained in addition to those of the first embodiment.

If the current output terminal 111 is connected to the collector of a power amplifier for a digital cellular phone, for example, and the power amplifier performs burst operation (i.e., operation in which ON/OFF operation is repeated in a fixed period), it takes a long time to stabilize a transition from OFF to ON because the impedance of the current output terminal 111 is high when the power amplifier is OFF. In view of this, the impedance fixing resistor 150 is inserted in this modified example, so that the transition is stabilized in a short time even in a system in which burst operation is repeated. As a result, the overcurrent protection circuit operates at higher speed.

### Embodiment 2

Hereinafter, an overcurrent protection circuit according to a second embodiment of the present invention will be described with reference to drawings.

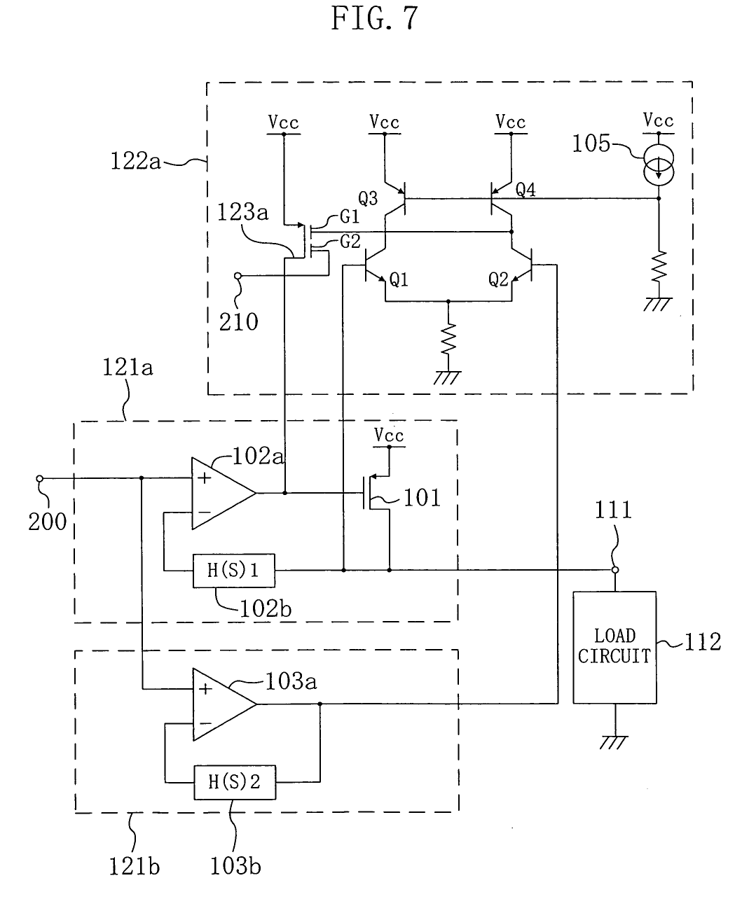

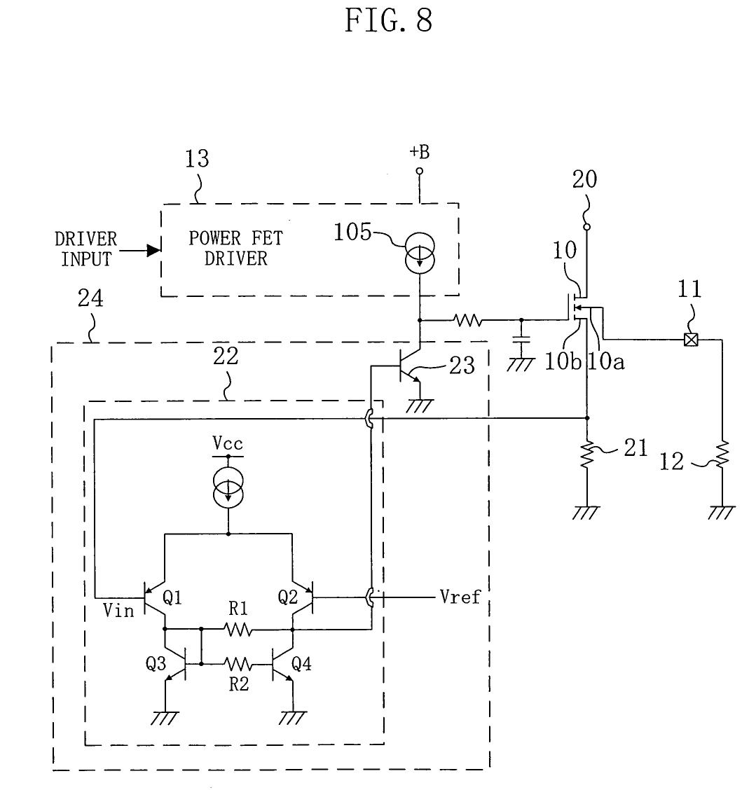

FIG. 7 is a diagram illustrating a specific example of a circuit for implementing a function of the overcurrent protection circuit of this embodiment. In FIG. 7, the same components as those of the overcurrent protection circuit of the first embodiment shown in FIG. 5 are denoted by the same reference numerals, and the description thereof will be omitted.

The overcurrent protection circuit of this embodiment is different from that of the first embodiment in that a dual-gate PMOSFET 123a is provided instead of the output PNP transistor 123 and an external control terminal 210 is further provided. The dual-gate PMOSFET 123a has a first gate G1 connected to the collector of a second NPN transistor Q2 and also has a second gate G2 connected to the external control terminal 210.

The external control terminal 210 supplies a voltage of 0 V or V_{cc} to the second gate G2 as a state of an external signal and, thereby, allows ON/OFF control of the function of an overcurrent detector 122a. It will be hereinafter described how this ON/OFF control is performed.

First, in a case where the external control terminal 210 supplies a voltage of 0 V to the second gate G2, since the second gate G2 is ON, the overcurrent detector 122a suppresses an overcurrent flowing in a load circuit 112 as in the first embodiment. That is, the function of the overcurrent detector 122a is ON.

Next, in a case where the external control terminal 210 supplies a voltage V_{cc} to the second gate G2, since the second gate G2 is OFF, the gate voltage V_{gs} of a power PMOSFET 101 cannot be controlled even with an application of a bias to the first gate G1 of the dual-gate PMOSFET 123a. That is, the function of the overcurrent detector 122a is OFF.

As described above, the function of the overcurrent detector 122a is controlled between ON and OFF, so that breakdown of the load circuit 112 and the power PMOSFET 101 caused by an overcurrent is prevented in the overcurrent protection circuit of this embodiment. In addition, the timing of operation of the overcurrent protection circuit is also controlled.

As in the modified example of the first embodiment, the overcurrent protection circuit of this embodiment may also include an impedance fixing resistor 150 inserted between a current output terminal 111 and a GND. Then, stabilization is established in a short time and the overcurrent protection circuit operates at higher speed even in a system in which burst operation is repeated.

As described above, the overcurrent protection circuit according to the present invention has the advantage that a constant output voltage is supplied to a load circuit and an overcurrent flowing in the load circuit is detected and suppressed so that breakdown of circuits or the like is prevented. For example, the overcurrent protection circuit of the present invention is useful as an overcurrent protection circuit for use in a power amplifier, for example, for a cellular phone.

1. An overcurrent protection circuit, comprising:
overcurrent detecting means for detecting a flow of an overcurrent in a load circuit; and
voltage controlling means for changing the level of a power supply voltage and supplying the resultant power supply voltage to the load circuit as a constant output voltage,
wherein the overcurrent detecting means detects a voltage decrease of the output voltage occurring during generation of an overcurrent, and
the voltage controlling means suppresses a current supplied to the load circuit based on the voltage decrease.

2. The overcurrent protection circuit of claim 1, wherein the voltage controlling means includes:
a voltage changer for changing the level of a received power supply voltage and for supplying the resultant power supply voltage to the load circuit as a constant output voltage; and
a voltage comparator for supplying a reference voltage for use in comparison with the output voltage in the overcurrent detecting means.

3. The overcurrent protection circuit of claim 2, wherein the voltage changer includes:
a first noninverting amplifier including a first feedback circuit; and
a large-current driving circuit for suppressing a decrease of the power supply voltage caused by a supply of a current to the load circuit.

4. The overcurrent protection circuit of claim 2, wherein the voltage comparator includes a second noninverting amplifier including a second feedback circuit, and
the voltage comparator changes the level of a received power supply voltage also input to the voltage changer and supplies the resultant power supply voltage to the overcurrent detecting means as a constant reference voltage.

5. The overcurrent protection circuit of claim 2, wherein the voltage changer includes:
a first noninverting amplifier including a first feedback circuit; and
a large-current driving circuit for suppressing a decrease of the power supply voltage caused by a supply of a current to the load circuit,
the voltage comparator includes a second noninverting amplifier including a second feedback circuit,
the voltage comparator changes the level of a received power supply voltage also input to the voltage changer and supplies the resultant power supply voltage to the overcurrent detecting means as a constant reference voltage, and
the first feedback circuit has a feedback coefficient larger than that of the second feedback circuit.

6. The overcurrent protection circuit of claim 3, wherein
the overcurrent detecting means includes:
a first NPN transistor having a base to which the output voltage is supplied;
a second NPN transistor having a base to which the reference voltage is supplied;
a first PNP transistor for supplying a bias to the first NPN transistor;
a second PNP transistor for supplying a bias to the second NPN transistor;
a constant current source for driving the first PNP transistor and the second PNP transistor; and
an output PNP transistor for controlling the large-current driving circuit,
wherein the first NPN transistor and the second NPN transistor form a differential pair controlled based on a potential difference between the output voltage and the reference voltage, and
the output PNP transistor is controlled by operation of the differential pair.

7. The overcurrent protection circuit of claim 6, wherein the overcurrent detecting means includes a dual-gate PMOSFET instead of the output PNP transistor,
the dual-gate PMOSFET has a first gate connected to a collector of the second NPN transistor, and
the dual-gate PMOSFET has a second gate controlled according to an external signal.

8. The overcurrent protection circuit of claim 5, wherein
the overcurrent detecting means includes:
a first NPN transistor having a base to which the output voltage is supplied;
a second NPN transistor having a base to which the reference voltage is supplied;
a first PNP transistor for supplying a bias to the first NPN transistor;
a second PNP transistor for supplying a bias to the second NPN transistor;
a constant current source for driving the first PNP transistor and the second PNP transistor; and
an output PNP transistor for controlling the large-current driving circuit,
wherein the first NPN transistor and the second NPN transistor form a differential pair controlled based on a potential difference between the output voltage and the reference voltage, and
the output PNP transistor is controlled by operation of the differential pair.

9. The overcurrent protection circuit of claim 8, wherein the overcurrent detecting means includes a dual-gate PMOSFET instead of the output PNP transistor,
the dual-gate PMOSFET has a first gate connected to a collector of the second NPN transistor, and
the dual-gate PMOSFET has a second gate controlled according to an external signal.

10. The overcurrent protection circuit of claim 8, wherein the second noninverting amplifier is constituted by a third PNP transistor,
the third PNP transistor has a base connected to an input of the voltage changer, and
the third PNP transistor has an emitter connected to the base of the second NPN transistor and to the constant current source.
